(19) United States
(12) Patent Application Publication
(10) Pub. No.: US 2026/0196677 A1
(43) Pub. Date: Jul. 9, 2026

(54) A SYSTEM COMPRISING STACKABLE MODULES FOR DETECTING AND RESPONDING TO A MOVING OBJECT

(71) Applicant: MODULEYE OY, Evitskog (FI)

(72) Inventor: Juha LAPPALAINEN, Evitskog (FI)

(21) Appl. No.: 19/131,971

(22) PCT Filed: Nov. 27, 2023
(86) PCT No.: PCT/FI2023/050649

§ 371 Date: May 22, 2025

(30) Foreign Application Priority Data
Nov. 26, 2022 (FI) 20226056
Dec. 23, 2022 (FI) 20226158

(51) Int. Cl. H01M 50/514; H01M 10/615; H01M 10/6571; H01M 50/204; H01M 50/503; H01M 50/691; H01R 13/52; H01R 13/62

(52) U.S. Cl. CPC H01M 50/514; H01M 10/615; H01M 10/6571; H01M 50/204; H01M 50/503; H01M 50/691; H01R 13/5227; H01R 13/6205

(57) ABSTRACT

A system for detecting and responding to a moving object, comprising multiple stackable modules. At least one battery module (20) comprising a first connector (11); and at least one functional module (21, 22, 23) comprising another first connector (11) and, at an opposite side of the functional module (21, 22, 23), a second connector (12) configured to be connected to the first connector (11) of another module; wherein the first connector (11) is a blind mate connector comprising at least one first magnet (16) having a polarity at first orientation; the second connector (12) is a blind mate connector comprising at least one second magnet (26), having a polarity reversed to the first magnet (16), or a ferromagnetic counterpart (16), such that each second connector (12) is connected to the first connector (11) in a predefined orientation. The first connector (11) comprises multiple first compression connectors (111) which protrude from the first connector surface, the second connector (12) comprises multiple second compression connectors (112) which protrude from the second connector surface, first compression connectors and second compression connectors (112) are partially embedded in a flexible material (15), and the mating surfaces of the first connector (11) and the second connector (12) are substantially flat.

### BACKGROUND

The present disclosure generally relates to modular sensor systems, configured to allow the user to provide customized area control systems. One exemplary embodiment is in military operations, installing security systems, surveillance devices or weapons control. The prior art knows systems having stackable sensor systems that may be deployed to gather and transmit environmental data. The modules may be stacked according to the customized need or each application. Modules may contain sensors, energy harvesters, energy storage devices, and/or wireless radios.

For military applications, the modular system must withstand natural elements, such as sunshine, rain, salt, mud, snow or ice. Modular systems are known to be vulnerable and break easily when used by military personnel under extremely stressful situations, or by conscripts under military drills. The devices are handled in dark and transported in extreme conditions. Electrical connector pins are susceptible to bending if any object should find its way between stacked modules.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A rugged, modular system comprises multiple modules that are connected to single device, when in use. Multiple functional modules are stackable, and when put together, form a customizable area control system. The stackable modules comprise connectors on opposite sides, providing electric currents and signals passing through the module. The connectors are blind mate connectors that are secured by at least one magnet. One embodiment has one pair of magnets on one connector's mating surface and another pair of magnets with opposite polarities on the other connector's mating surface. The arrangement ensures that the modules may be stacked in only one orientation.

The mating surfaces between stacked modules and said connectors are substantially flat. In this context, substantially flat means that the mating surface has mellow tapered edge or slightly oblique surfaces providing guidance for the blind mate connector and to assist in disassembling connection between modules. The electrical contacts protrude slightly from the mating surface, when the module is disconnected. The module may stand on a flat surface on the mating surface.

The substantially flat surface provides ruggedness to the system. In heavy outdoor use, for example during the winter, snow and ice may accumulate to devices, and cover connectors' mating surfaces. The mechanical contact between connectors is provided by magnets, that may quickly lose the fastening effect if the distance between the mating surfaces is hindered by few millimetres. If the mating surface would have any deep corners or cavities, water or snow could accumulate and freeze into blocks that hinder full contact.

Thin layers of ice could reduce the functionality. As the mating surface is substantially flat, it may be wiped clean with a glove and/or quick shake.

The substantially flat mating surface has channels configured to allow accumulated water to flow out from the compressed mating surfaces. The electronic device, such as the module, dissipates heat and may melt the frost or ice from the surface. The channel alleviates removing the water from the mating surface, especially when pushed against another mating surface. In one embodiment, water removal is effected and defrosting is alleviated by having a hydrophobic coating or hydrophobic material at the mating surface.

One module is a battery module that is configured to provide electrical power to other modules. The electrical connections pass through the modules, from a first connector on one side of the module to the second connector on the opposite side of the module. The battery voltage may be higher when the electric current is fed to the power connections. The voltage may be stepped down when it is driving the electronics inside the functional module. The system may comprise various functional elements that may be selected according to desired function. The rugged system is fault tolerant, since any malfunctioning module may be simply swapped to a functional module.

The functionality of the system may be suitable for military purposes, such as securing perimeters or providing surveillance. Examples of possible functions that the functional module may provide comprise: camera, IR-camera, microphone, drone detection, drone interference, wired transceiver, wireless transceiver, motion sensor, passive infrared motion sensor, ultrasound motion sensor, proximity sensor, light curtain, light gate, illumination, detonation unit and self-destruction unit. Several devices may be networked and together provide more advanced surveillance systems.

Many of the attendant features will be more readily appreciated as they become better understood by reference to the following detailed description considered in connection with the accompanying drawings. The embodiments described below are not limited to implementations which solve any or all the disadvantages of modular area control systems or devices.

### BRIEF DESCRIPTION OF THE DRAWINGS

The present description will be better understood from the following detailed description read in light of the accompanying drawings, wherein

FIG. 1 illustrates schematically a sectional view of one exemplary embodiment of a system;

FIG. 2 illustrates schematically a sectional view of a separated connection between a battery module and a first functional module;

FIG. 3a illustrates schematically a top view of a first connector mating surface;

FIG. 3b illustrates schematically a sectional detail view of the mating surface;

FIG. 4a illustrates schematically a top view of one exemplary embodiment of compression connectors on the first connector;

FIG. 4b illustrates schematically a top view of another exemplary embodiment of compression connectors on the first connector;

FIG. 5 illustrates schematically multiple views of one exemplary embodiment of asymmetrical modules;

FIG. 6 illustrates schematically a sectional side view and top view of one exemplary embodiment of the system and the connector arrangement;

FIG. 7 illustrates schematically multiple views of one exemplary embodiment of stackable modules;

FIG. 8a illustrates schematically a top view of another exemplary embodiment of magnet placement;

FIG. 8b illustrates schematically a top view of another alternative embodiment of magnet placement;

FIG. 8c illustrates schematically a top view of another alternative embodiment of magnet placement;

FIG. 9 illustrates schematically a sectional side view of one exemplary embodiment of the shape of the substantially flat module's mating surface;

FIG. 10a illustrates schematically a view of one example of a transceiver module;

FIG. 10b illustrates schematically a view of one example of a detector module;

FIG. 10c illustrates schematically a view of one example of an I/O module;

FIG. 10d illustrates schematically a view of one example of a battery module;

FIG. 11a illustrates schematically a side view of one example of the first connector mating surface;

FIG. 11b illustrates schematically a side view of one example of a second connector mating surface;

FIG. 11c illustrates schematically a side view of the first connector and the second connector approaching a contact;

FIG. 11d illustrates schematically a side view of the first connector and the second connector in contact;

FIG. 12a illustrates schematically multiple views of the functional module without the connector surfaces assembled; and

FIG. 12b illustrates schematically multiple views of the functional module with the connector surfaces assembled.

Like reference numerals are used to designate like parts in the accompanying drawings.

### DETAILED DESCRIPTION

The detailed description provided below in connection with the accompanying drawings is intended as a description of the present examples and is not intended to represent the only forms in which the present example may be constructed or utilized. However, the same or equivalent functions and sequences may be accomplished by different examples.

Although the present examples are described and illustrated herein as being implemented in area control or surveillance purposes, a system, a host device, a client device or a method described are provided as an example and not a limitation. As those skilled in the art will appreciate, the present examples are suitable for application in a variety of different types devices configured to react for moving objects.

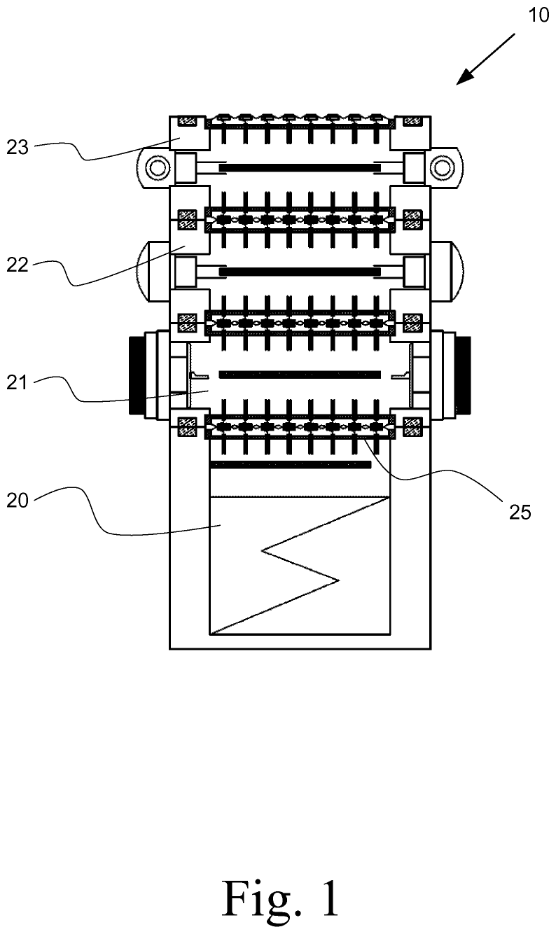

FIG. 1 illustrates schematically a sectional view of one exemplary embodiment of a system 10 for detecting and responding to a moving object. One practical application for the system is in military operations, such as area control, detecting hostile movement, vehicles, people, animals or drones. The exemplary system 10 comprises four modules that are operable when stacked together. The exemplary system 10 comprises a battery module 20 that houses one or more battery cells in order to provide electric power to the system 10. On top of the battery module 20 is a first functional module 21, a processor module, comprising a processor and a memory storing instructions that, when executed, cause the system 10 or any individual module to perform the steps as disclosed hereinafter. Attached over the processor module 21 is a second functional module 22, a motion detector module comprising means for detecting moving objects. In the present example the motion detector module comprises a PIR detector (PIR, Passive Infrared). Alternatively, or in addition, the motion sensor module may comprise camera, IR-camera, ultraviolet detector, ultrasonic detector, microwave detector, compact surveillance radar, MEMS accelerometer, metal detector or any other sensor that is suitable for detecting a moving object. The third functional module 23 is a communication module, comprising a transceiver. The communication may be wired or wireless. The radio interface may be analogue or digital. The communication module may be used to trigger external devices in response to the detected motion. In one embodiment, the functions within the functional modules 21-23 may be distributed or bundled to various alternative modules. Likewise, the system 10 may comprise various number of functional modules, not limiting the total number to three, as in the present example.

In this context directions, such as up, down, horizontal, vertical, etc., are described in reference to the gravity and conventional working positions. The modules 20-23 are stackable to any direction, as they are fastened together and the complete system 10 is typically hand-held. Dimensions of the exemplary embodiment are defined in the context of a portable device. In a hand-held system 10, the stacked modules may be orientated to any direction. The system 10 may be installed as a stand-alone device for controlling and/or monitoring an area or a space, by fastening the system 10 to a desired position: for example to a tree, a lamp post, to a pole, or a structure in an urban environment. One exemplary module is an attachment module that comprises one or more devices configured to quickly attach the system 10 to various surfaces: adhesive, wire sling, wire, rope, hook, self-retracting reel or similar device.

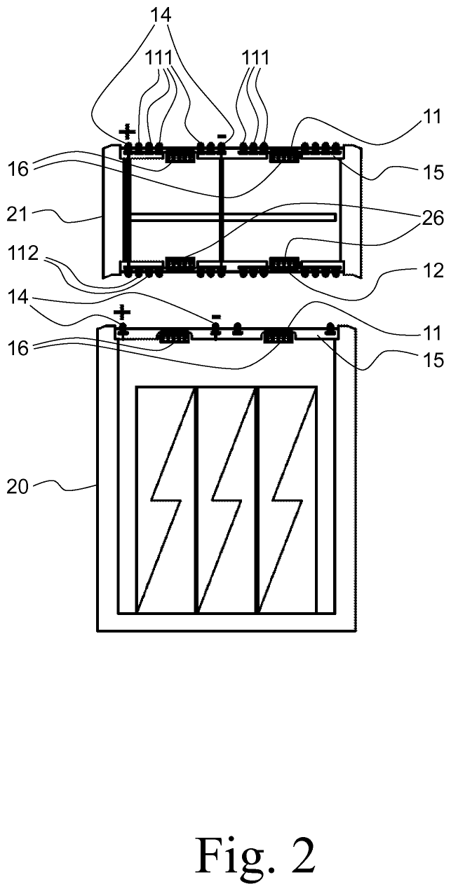

The system 10 may comprise multiple battery modules 20. The battery cells inside the battery module 20 may be replaceable. The battery module 20 comprises a first connector 11 that is configured to be connected to a second connector 12 of another module, for example one of the functional modules 21-23. FIG. 2 illustrates schematically a sectional view of the separated connection between the battery module 20 and the first functional module 21. The functional module 21 comprises two connectors on opposite sides. The second connector 12 of the first functional module 21 is configured to be connected to any first connector 11. The mating surfaces of the first connector 11 and the second connector 12 provide a blind mate connector. The blind mate connector comprises a mating action that happens via a sliding or snapping action which can be accomplished without wrenches or other tools. The modules 20-23 may be connected manually. In the present example the blind mate connector functionality is provided by mating surface's shapes and magnets 16, 26. These elements provide the self-alignment which allows a small misalignment when mating modules manually.

The first connector 11 comprises at least one first magnet 16 having a polarity at first orientation. The second connector 12 comprises at least one second magnet 26, having a polarity reversed to the first magnet 16, such that each second connector 12 is connected to the first connector 11 in a predefined orientation. In the exemplary embodiment of FIG. 2, the first connector 11 comprises a pair of first magnets 16 having a polarity at first orientation; and the second connector 12 comprises a second pair of second magnets 26, having a polarity reversed to the pair of first magnets 16, such that each second connector 12 is connected to the first connector 11 in a predefined orientation. For example, if the first magnet 16 has the north pole exposed, then the second magnet 26 has the south pole exposed. Within one single functional module, the first connector 11 and the second connector 12 have the same orientation. In one embodiment, the second connector 12 is connectable to the first connector 11 only in the predefined orientation.

The magnets 16, 26 function together with the surface shapes in that the surface shape does not allow the magnets 16, 26 of mating surfaces to get in contact in wrong positions. If the user attempt to install the modules incorrectly, the magnets 16, 26 are further from their correct positions. The magnetic force decreases rapidly as a function of distance, and even small distance between the opposite magnets 16, 26 does not allow them to click together. In one embodiment, the first magnet 16 is made of ferromagnetic metal. In one embodiment, the first magnet 16 is an electromagnet.

In one embodiment, the second magnet 26 on the second connector 12 is a ferromagnetic counterpart 26. In one embodiment, the first magnet 16 is configured to be connected to the ferromagnetic counterpart 26. In one embodiment, the second magnet 26 is made of ferromagnetic metal. In one embodiment, the second magnet 26 is an electromagnet.

The mating surfaces of the first connector 11 and the second connector 12 are substantially flat. Substantially flat is defined as a flat profile, allowing small deviations in the surface shape to provide the shape guidance and the electrical connectors. The mating surface of the first connector 11 and the second connector 12 may comprise mellow tapered edges or slightly oblique surfaces. The angled portions of the mating surfaces provide guidance for the blind mate connector during the assembly of the system 1. Alternatively, or in addition, the angled portions are configured to assist in disassembling the system, for example rotating the stacked modules cause the connection to disengage.

According to one definition, the substantially flat surface supports the module 20-23 sufficiently to enable it to stand stably over perfectly flat surface. In one embodiment, the flat mating surface has surface shapes that extend less that 3 mm above the average baseline.

The substantially flat surface is easier to maintain during difficult weather conditions. For example water may be simply wiped from the surface when installing the system 10. In military conditions, mere fractions of a second may be decisive factors when installing the system 10 to a surveillance location to perform area control. Mud, sand, dirt, dust or other debris is less likely to accumulate in the substantially flat surface, which must be relatively clean as the connection will be upheld by magnets 16, 26.

The first connector 11 comprises multiple first compression connectors 111 which protrude from the first connector surface, and the second connector 12 comprises multiple second compression connectors 112 which protrude from the second connector surface. The compression connectors 111, 112 protrude few millimetres from the mating surface, still enabling the magnets 16, 26 to pull the connection into closed state. The compression connectors 111, 112 cause an opposite force to the magnets 16, 26; the magnets 16, 26 are chosen to provide sufficiently strong force to compensate the push from the compression connectors 111, 112. The compression connectors 111, 112 provide the electric connection between the mating surfaces when they are compressed against each other.

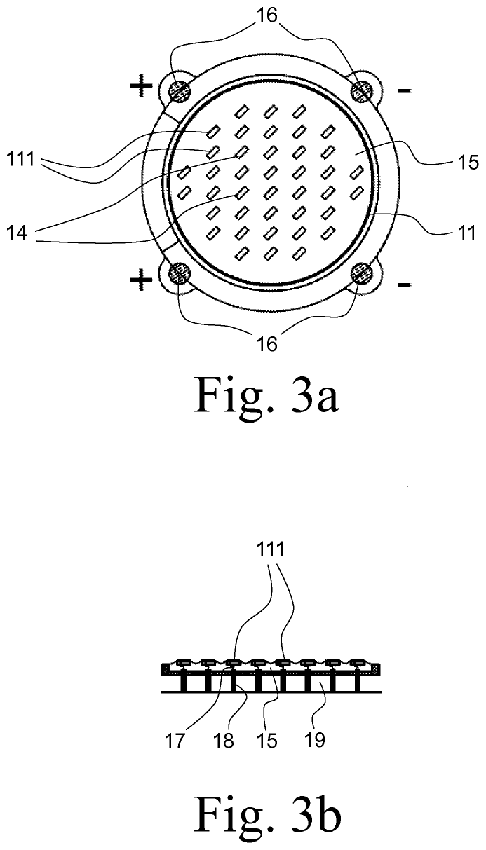

In one embodiment, first compression connectors 111 and second compression connectors 112 are partially embedded in a flexible material 15. FIG. 3a illustrates schematically a top view of the first connector 11 mating surface, and FIG. 3b a sectional detail view. The electronics or other components of the functional module 21-23 may be epoxied within the internal cavities, or the functional module 21-23 may be filled with other solidifying material. Out of the solid inner portion, a contact wire 17 is led to the first compression connectors 111. The contact wire is further connected to internal electric devices inside the functional module 21-23, for example to an electric conductor 18. The flexible material 15 is in one embodiment configured to allow the first compression connectors 111, and similar second compression connectors 112, to be pushed downwards. The allowable movement range may be 0.1 mm . . . 2 mm.

In one embodiment, the compression connector 111, 112 comprises a pin lying parallel and slightly above to the flexible material 15 surface. The pin may have longitudinal, rectangular or oval appearance above the flexible material 15 surface. At least one end of the pin comprises a contact wire configured to carry an electric current or signal to the module and/or to the surface on the other side of the module.

Alternatively, or in addition, the movement of the compression connectors 111, 112 is provided by a bent spring shape of the connector. In one embodiment, the compression connector 111, 112 is a spring-loaded pin or a pogo pin.

In one embodiment, the flexible material 15 is an elastomer. Elastomers are polymers with viscoelasticity and high failure strain. The elastomer may be selected to retain its viscoelasticity in winter conditions and the modulus of elasticity in tension or compression being suitable to allow proper movement for the compression connectors 111. The flexible material 15 provides ingress protection for the modules 20-23. In addition, the module 20-23 may be filled with epoxy 19 or similar non-reactive material that protects the internal components. In one embodiment, the modules 20-23 are not serviceable, instead the modules may be quickly swapped for a functional one if one should malfunction. The whole complex system of sensors and transceivers does not need to be discarded if only one component malfunctions.

In one embodiment, the mating surface comprises hydrophobic coating or hydrophobic material that repels water. Therefore, the module 20-23 would be less likely to collect ice or frost on the mating surface.

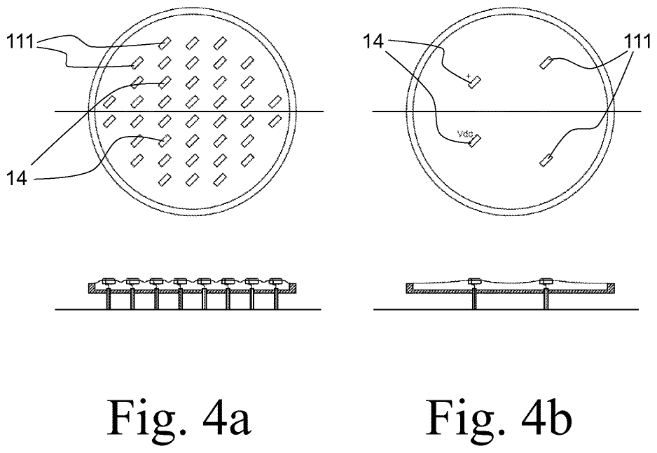

In the present example of FIG. 2, the battery module 20 comprises only compression connectors for the electric power 14. The functional modules 21-23 have the full arrangement of compression connectors 111, 112. In one embodiment, the first connector 11 of the battery module 20 comprises the full arrangement of compression connectors 111, 112. In an embodiment, the first connector 11 and the second connector 12 in the same module 20-21 comprise the full arrangement of compression connectors 111, 112 and allow the electric currents and signals to pass through the module, from the first connector 11 to the second connector 12. FIG. 4a and FIG. 4b illustrate schematically two exemplary embodiments of different compression connector numbers on the first connector 11. The example of FIG. 4a shows all compression connectors 111 of the embodiment. The example of FIG. 4b shows only the compression connectors for the electric power 14 and two compression connectors 111.

In one exemplary embodiment, the system 10 utilizes at least two voltages. The source voltage from the battery module 20 may be higher than the voltage used by the functional modules. In one example the voltage provided by the battery module 20 is 25.9 V; provided by seven 3.7 V Li-Ion battery cells. Each functional module 21-23 may step down the source voltage to be suitable for the module's purpose. Other battery cell configurations or battery types may be used. In one embodiment, the battery module 20 comprises a supercapacitor.

The modules 20-23 are purposed to be used in outdoor conditions. For example, in the Arctic regions, operations under freezing temperatures are normal. In one embodiment, the mating surface of the battery module 20 comprises a heating element 25 configured to melt ice from the mating surface. In one embodiment, the functional element 21-23 comprises the heating element 25. In one embodiment, the heating element is provided by the normal operation of the module 20-23, wherein the heat dissipation is directed towards the mating surface. The heating element 25 of the battery module may be used to melt mating surfaces of other modules.

In one embodiment, the mating surface of the first connector 11 comprises at least one channel 50 allowing accumulated water to flow out from the closed connection between two modules. In one embodiment, the mating surface of the second connector 12 comprises at least one channel 50 allowing accumulated water to flow out from the closed connection between two modules. The channels 50 are, in one embodiment, extended to the flexible material 15. For example, during winter conditions, loose snow may be compressed into ice between the two mating surfaces. The residual heat from the system may melt the ice, or the user may wipe off most of the snow. The channel ensures, that the water will not be trapped between the mating surfaces.

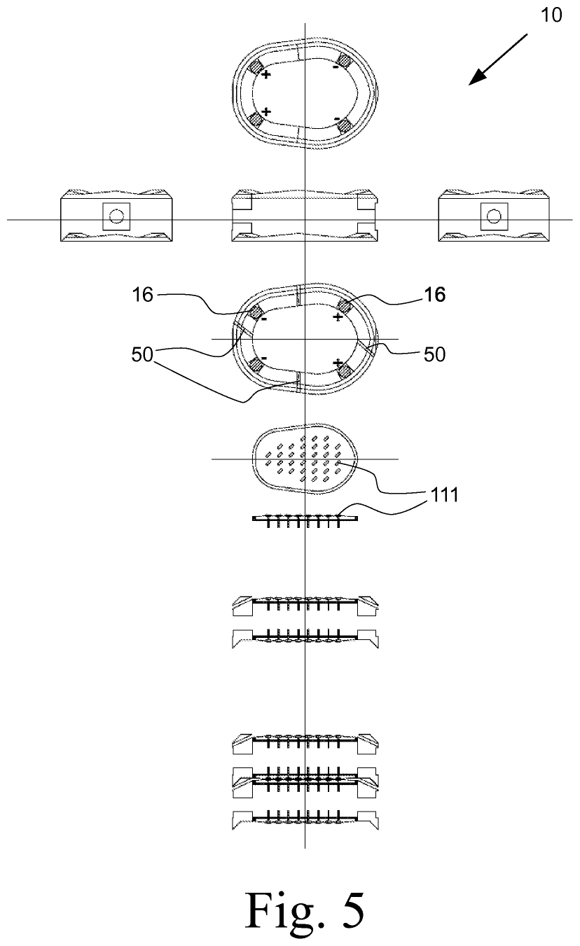

FIG. 5 illustrates schematically multiple projections of one embodiment of the system 10 having asymmetrical design. The profile may be tactile for the user to intuitively operate the blind mate connectors to correct orientation. The side surfaces may comprise different textures at different sides of the system 10.

In the examples of flat compression connectors 111,112 as illustrated in FIG. 1 to FIG. 5, the compression connectors 111, 112 have a direction and an alignment. In one embodiment, the first compression connectors 111 are configured to bend at a first direction, and the second compression connectors 112 are configured to bend at a second direction, when the first connector 11 is connected to the second connector 12. In one embodiment, the angle between the first direction and the second direction is between 70 and 110 degrees. In one embodiment, the angle between the first direction and the second direction is 90 degrees. The first compression connectors 111 and the second compression connectors 112 are, in one embodiment, configured to bend when in compressed state and resume the original position when the compression is released. In one embodiment, the compression connectors 111, 112 are configured to be depressed into the flexible material 15. In one embodiment, the compression connectors 111, 112 comprise a spring that operates in lateral direction, towards the mating surface. In one embodiment, the connector 111, 112 is made of sheet metal that provides the spring function.

The direction of bending on the compression connector 111, 112 is defined by the longitudinal, rectangular or oval appearance of the compression connector 111, 112 embedded into the flexible material 15. The flexible material 15 allows the compression connector 111, 112 to move slightly inside the flexible material 15 when the mating compression connector 111, 112 from the other surface is connected and the magnets 16, 26 pull the mating surfaces together. The magnets 16, 26 start pulling when the mating surfaces are near each other and aligned correctly. The compression connectors 111, 112 may move slightly inside the flexible material 15 by one side first, as the mating compression connector 111, 112 pushes it from one end—before the magnets 16, 26 fully align the mating surfaces and the mating compression connectors 111, 112 are having contacts from their middle portions. The slight scraping effect may clean the compression connector's open surfaces from any excess materials, or in one embodiment, remove oxidation form the metal surface.

FIG. 6 illustrates schematically a sectional side view and top view of one exemplary embodiment of the system and the connector arrangement. In this exemplary embodiment the first connector 11 comprises compression connectors 111. The second connector 12 comprises circular connectors 12 that are configured to ensure connection even if the orientation between the mating surfaces is not perfect. The shape of the system is cylindrical in this embodiment. The magnets 16, 26 are arranged inside the mating surfaces. The magnets 16, 26 may be placed on only one of the connectors 11 or 12, wherein the mating surface comprises tabs made of ferrous metal, to complete the alignment of the blind mate connector.

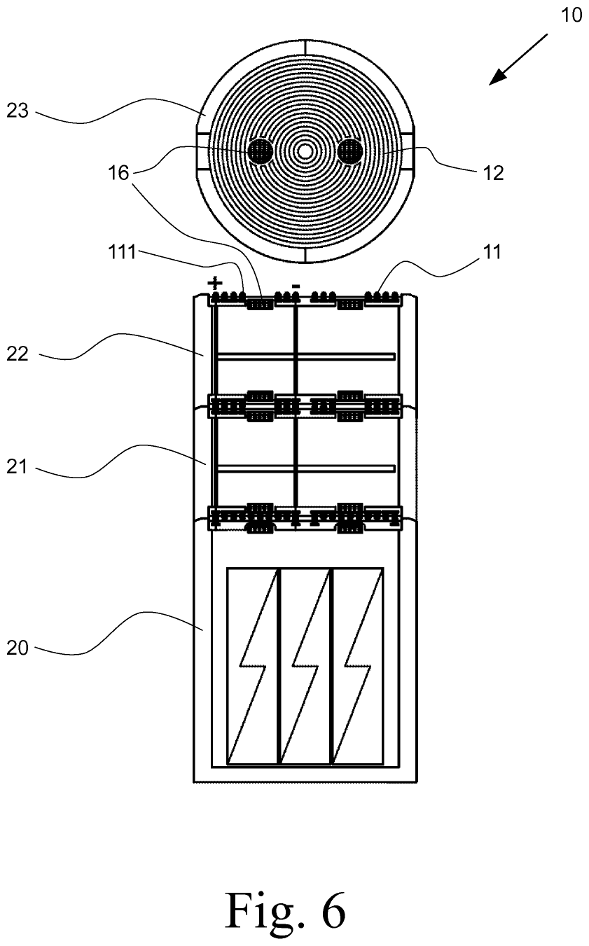

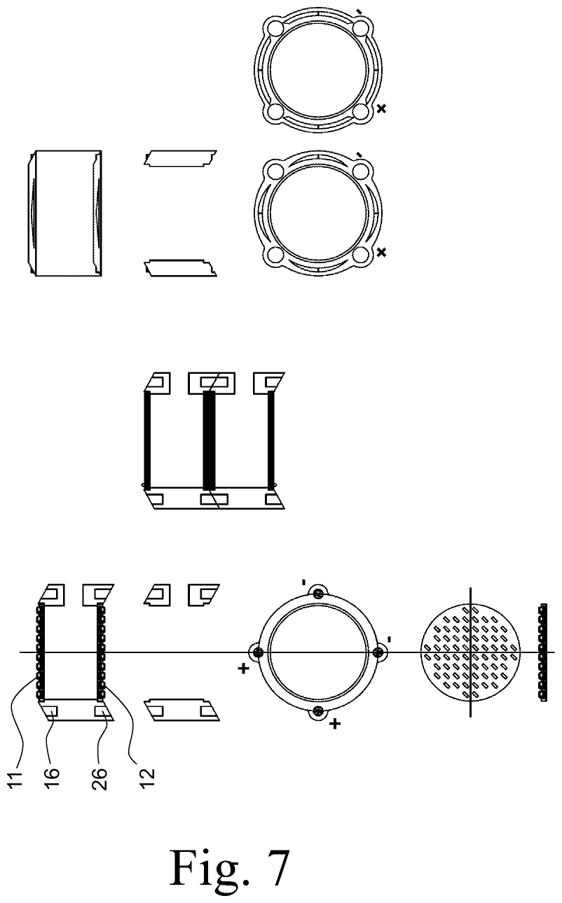

FIG. 7 illustrates schematically multiple views of one exemplary embodiment of stackable modules. In this example the sides of the mating surfaces have been shaped to assist rotating movement between the modules. In this example the cylindrical shape comprises slanted outer perimeter. Different shapes on the module's 20-23 mating surface can be used to help separate the modules 20-23 from each other by rotating two attached modules 20-23 in opposite directions. FIG. 9 illustrates schematically a sectional side view of another example of the outer perimeter of the mating surface that assists in the blind mate connection. These examples may be regarded as extreme examples of the substantially flat surface.

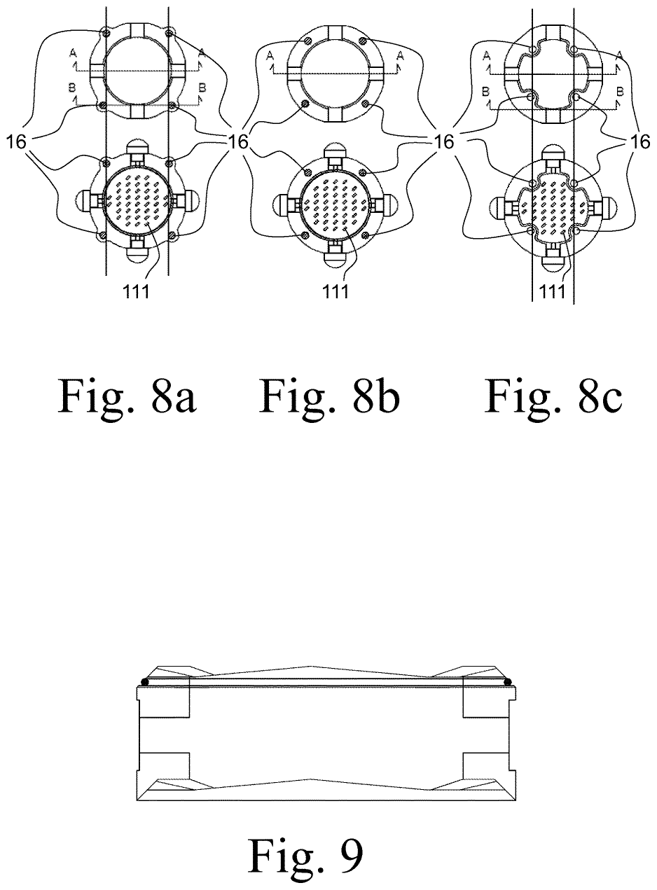

FIG. 8a-FIG. 8c illustrate schematically various examples of magnet 16 placement in the mating surface. In these examples the magnets may be placed on the outer or inner perimeter on the mating surface.

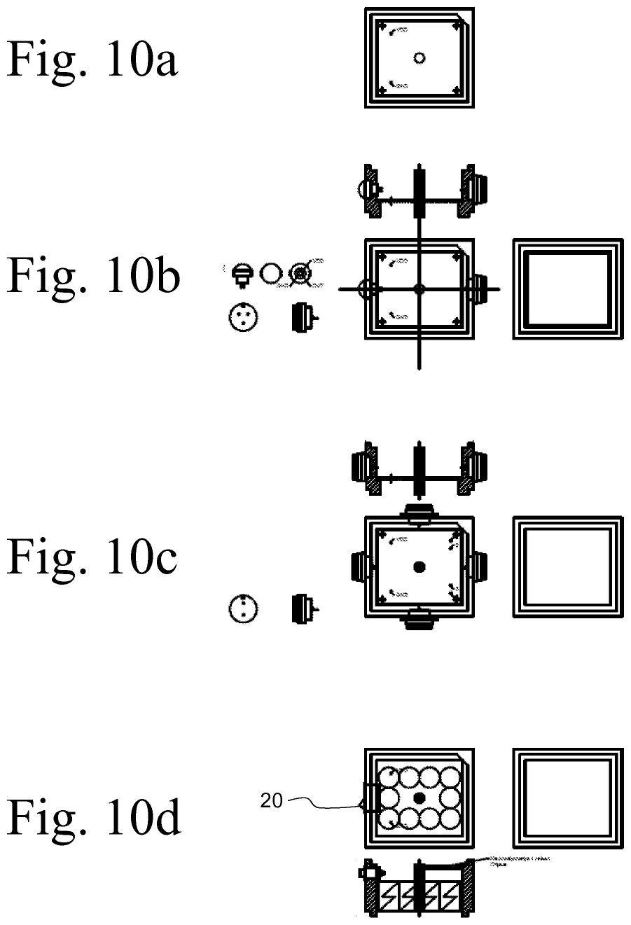

FIG. 10a-FIG. 10d illustrate an exploded view of the system 10, wherein the outer shape of each module is boxy, with rectangular sides. FIG. 10a illustrates one example of a transceiver module, for example a radio. For the area control application, suitable transmission range is 5 kilometres but may vary depending on need and topography. Several systems 10 may be networked and operated by a host system, or alternatively any device may be assigned as the host device.

FIG. 10b illustrates one example of a detector module. The detector module may comprise various known detector systems. In one embodiment, two adjacent detector modules may operate together and create an infrared light curtain that will cause an alarm in the host system when interrupted.

FIG. 10c illustrates schematically multiple views of an I/O module, that comprises transceiver capabilities and ability to operate external devices. The I/O module may activate an external device, send an activation signal to external device, for example detonate an explosive, switch on drone countermeasures or provide interface to various external systems.

FIG. 10d illustrates schematically multiple views of one example of a battery module. The battery module 20 comprises multiple battery cells that are, in one embodiment, replaceable. The battery module 20 may provide electrical power to various devices and systems that have a second connector 12 that matches the output of the first connector 11 arranged into the battery module 20.

In one embodiment, the first connector 11 is a charger for a flying drone, wherein the drone may land onto the first connector 11 residing in a distant place. In one embodiment, the interface of the first connector 11 is available in the system 10 on the top module on the stack. The drone may land on the top module or on the battery module 20, charge drone's battery and take off from the first connector 11. In one embodiment, the connector on the drone may be an adapted version of the second connector 12, wherein the magnetic force applied to the first connector 11 is reduced or controllable. The drone connector may comprise similar shape as the second connector 12 to properly seat onto the first connector 11. The drone connector may comprise an electromagnet that is configured to connect to the first magnet 16. In one embodiment, the first connector 11 comprises at least one tab made of ferrous metal, configured to interact with the drone's electromagnet or any second magnet 26 on the second connector 12.

In one embodiment, the battery module 20 comprises different profile than the rest of the modules in the system 10. In one embodiment, the battery module 20 is wider than the rest of the stack. In one embodiment, wide battery module 20 provides a landing platform for the drone. In one embodiment, the battery module is a reserve power supply or an emergency power supply to an external electric system. In one embodiment, the first connector 11 may be connected to any external device. In one embodiment, the battery module 20 is connected to the stack of the system 10, wherein the system 10 comprises an interface module configured to provide electric power connector to an external device.

In one embodiment, the stackable module comprises at least one function selected from the group of: camera, microphone, drone detection, drone interference, wired transceiver, wireless transceiver, motion sensor, passive infrared motion sensor, ultrasound motion sensor, light curtain, light gate, proximity sensor, illumination, detonation unit and self-destruction unit. The system 10 may be used to detect vehicles, drones or people and initiate proper action in response. For example, the motion detector may activate the camera module, wherein the actions are monitored in the central control room. With secured visual contact provided by the system 10, an explosive may be detonated from a distance.

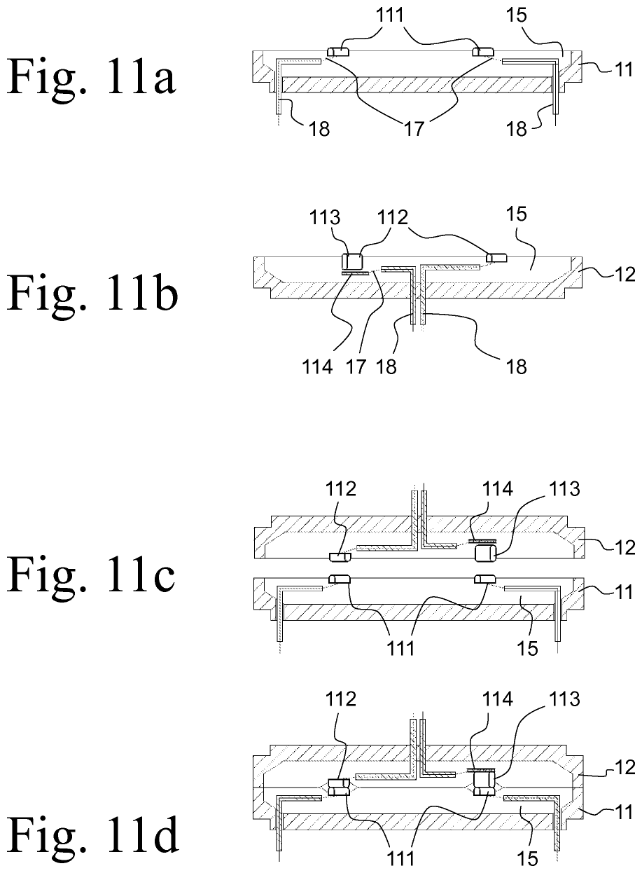

FIG. 11a-FIG. 11d illustrate multiple side views of the first connector 11 and the second connector 12, without the magnets that are positioned on the outer perimeter of the connectors 11, 12. In FIG. 11a the first connector 11 comprises the mating surface having the first compression connectors 111 standing partially embedded in the flexible material 15. FIG. 11b illustrates the second connector 12, with a power switch 113, 114. The power switch comprises a switch pin 113 partially embedded in the flexible material 15 and a switch plate 114 being fully embedded in the flexible material and close to the switch pin 113. In one embodiment, the space between the switch pin 113 and the switch plate 114 is not filled with flexible material 15. Pressing the switch pin 113 causes it to be in contact with the switch plate 114. In one embodiment, the flexible material allows the switch pin 113 to move through the flexible material 15. FIG. 11c shows the second connector 12 being flipped and approaching the first connector 11. In FIG. 11d the first connector 11 and the second connector 12 are in contact. The compression caused by the magnets between the first connector 11 and the second connector 12, pushes the switch pin 113 to be in contact with the switch plate 114.

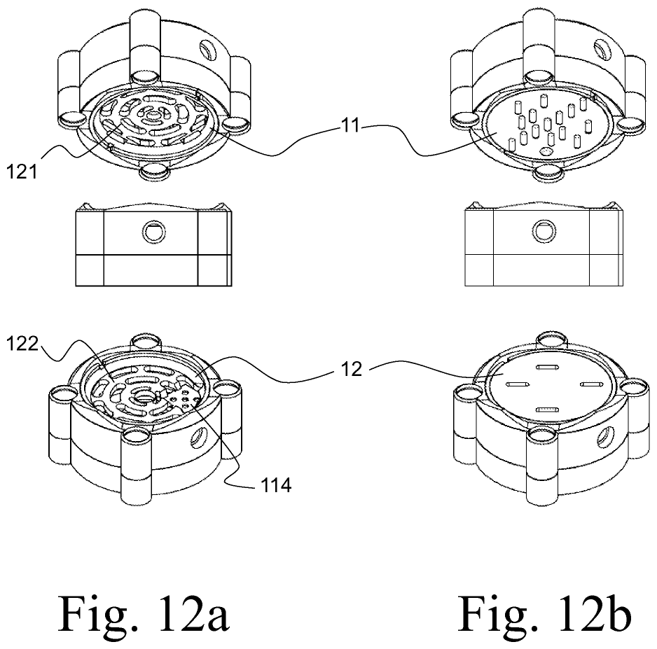

FIG. 12a illustrates multiple views of on exemplary embodiment, wherein the functional module is illustrated without the connector surfaces assembled. In one embodiment, a first assembly plate 121 comprises multiple openings that allow the contact wire 17 to pass through the first assembly plate 121. The first assembly plate 121 is used to manufacture the first connector 11. In one embodiment, a second assembly plate 122 comprises multiple openings that allow the contact wire 17 to pass through the second assembly plate 122. The first assembly plate 121 is used to manufacture the first connector 11. During an assembly stage, the compression contactors 111, 112 are placed on the assembly plate 121, 122. Also, the switch plate 114 is placed in the assembly plate 122 at this stage. Contact wires 17 pass through the assembly plate 121, 122 to be in contact with electric conductor 18 or other components inside the functional module. FIG. 12b illustrates schematically multiple views of the functional module with the connector surfaces of the FIG. 12a assembled.

Herein is disclosed a system for detecting and responding to a moving object, comprising multiple stackable modules. Said modules comprise at least one battery module comprising a first connector; and at least one functional module comprising another first connector and, at an opposite side of the functional module, a second connector configured to be connected to the first connector of another module; wherein the first connector is a blind mate connector comprising at least one first magnet having a polarity at first orientation; the second connector is a blind mate connector comprising at least one second magnet, having a polarity reversed to the first magnet such that each second connector is connected to the first connector in a predefined orientation. The first connector comprises multiple first compression connectors which protrude from the first connector surface, the second connector comprises multiple second compression connectors which protrude from the second connector surface, first compression connectors and second compression connectors are partially embedded in a flexible material, and the mating surfaces of the first connector and the second connector are substantially flat. In one embodiment, the mating surface of the first connector comprises at least one channel allowing accumulated water to flow out from the closed connection between two modules. In one embodiment, the mating surface of the battery module comprises a heating element configured to melt ice from the mating surface. In one embodiment, the first compression connectors are configured to bend at a first direction, and the second compression connectors are configured to bend at a second direction, when the first connector is connected to the second connector. In one embodiment, the angle between the first direction and the second direction is between 70 and 110 degrees. In one embodiment, the flexible material is an elastomer.

Alternatively, or in addition, a stackable module for a system described hereinbefore is disclosed. The module comprises a first connector and, at an opposite side of the module, a second connector configured to be connected to the first connector of another module; wherein the first connector is a blind mate connector comprising at least one first magnet having a polarity at first orientation; the second connector is a blind mate connector comprising at least one second magnet, having a polarity reversed to the first magnet (16) such that each second connector is connectable to the first connector of another stackable module in a predefined orientation. The first connector comprises multiple first compression connectors which protrude from the first connector surface, the second connector comprises multiple second compression connectors which protrude from the second connector surface, first compression connectors and second compression connectors are partially embedded in a flexible material, and the mating surfaces of the first connector and the second connector are substantially flat. In one embodiment, the mating surface of the first connector comprises at least one channel allowing accumulated water to flow out from the closed connection between two stackable modules, when the stackable module is connected to another stackable module. In one embodiment, the mating surface of the module comprises a heating element configured to melt ice from the mating surface. In one embodiment, the first compression connectors are configured to bend at a first direction, and the second compression connectors are configured to bend at a second direction, when the first connector is connected to the second connector of another stackable module. In one embodiment, the angle between the first direction and the second direction is between 70 and 110 degrees. In one embodiment, the flexible material is an elastomer. In one embodiment, the compression connector is a spring-loaded pin. In one embodiment, the mating surface comprises a hydrophobic coating. In one embodiment, the stackable module comprises at least one function selected from the group of: camera, microphone, drone detection, drone interference, wired transceiver, wireless transceiver, motion sensor, passive infrared motion sensor, ultrasound motion sensor, light curtain, light gate, proximity sensor, illumination, detonation unit and self-destruction unit. In one embodiment, the second connector comprises a power switch wherein a switch pin is partially embedded into the flexible material, and pressing the switch pin causes it to be in contact with a switch plate embedded inside the flexible material.

Alternatively, or in addition, the controlling functionality described herein can be performed, at least in part, by one or more hardware components or hardware logic components. An example of the area control system described hereinbefore is a computing-based device comprising one or more processors which may be microprocessors, controllers or any other suitable type of processors for processing computer-executable instructions to control the operation of the device in order to control one or more sensors, receive sensor data and use the sensor data. The computer-executable instructions may be provided using any computer-readable media that is accessible by a computing-based device. Computer-readable media may include, for example, computer storage media such as memory and communications media. Computer storage media, such as memory, includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media is shown within the computing-based device, it will be appreciated that the storage may be distributed or located remotely and accessed via a network or other communication link, for example, by using a communication interface.

The apparatus or the device may comprise an input/output controller arranged to output display information to a display device which may be separate from or integral to the apparatus or device. The input/output controller is also arranged to receive and process input from one or more devices, such as a user input device (e.g. a mouse, keyboard, camera, microphone or other sensor).

The methods described herein may be performed by a software in machine-readable form on a tangible storage medium e.g. in the form of a computer program comprising computer program code means adapted to perform all the steps of any of the methods described herein when the program is run on a computer and where the computer program may be embodied on a computer-readable medium. Examples of tangible storage media include computer storage devices comprising computer-readable media, such as disks, thumb drives, memory etc. and do not only include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

Any range or device value given herein may be extended or altered without losing the effect sought.

Although at least a portion of the subject matter has been described in language specific to structural features and/or acts, it is to be understood that the subject matter defined in the accompanying claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or device may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A system for detecting and responding to a moving object, comprising multiple stackable modules, having:
at least one battery module comprising a first connector; and
at least one functional module comprising another first connector and, at an opposite side of the functional module, a second connector configured to be connected to the first connector of another module; wherein
the first connector is a blind mate connector comprising at least one first magnet having a polarity at first orientation;
the second connector is a blind mate connector comprising at least one second magnet having a polarity reversed to the first magnet, or a ferromagnetic counterpart, such that the second connector is connected to the first connector, in a predefined orientation;
wherein
the first connector comprises multiple first compression connectors which protrude from the first connector surface;
the second connector comprises multiple second compression connectors which protrude from the second connector surface;
the first compression connectors and the second compression connectors are partially embedded in a flexible material;
the mating surfaces of the first connector and the second connector are substantially flat; and
the first compression connectors are configured to bend at a first direction, and the second compression connectors are configured to bend at a second direction, when the first connector is connected to the second connector.

2. A system according to claim 1, wherein the mating surface of the first connector comprises at least one channel allowing accumulated water to flow out from the closed connection between two modules.

3. A system according to claim 1, wherein the mating surface of the battery module comprises a heating element configured to melt ice from the mating surface.

4. A system according to claim 1, wherein the angle between the first direction and the second direction is between 70 and 110 degrees.

5. A system according to claim 1, wherein the flexible material is an elastomer.

6. A stackable module for a system according to claim 1, comprising:
a first connector, and,
at an opposite side of the module, a second connector configured to be connected to the first connector of another module; wherein
the first connector is a blind mate connector comprising at least one first magnet having a polarity at first orientation;
the second connector is a blind mate connector comprising at least one second magnet having a polarity reversed to the first magnet, or a ferromagnetic counterpart, such that the second connector is connectable to the first connector of another stackable module in a predefined orientation;
wherein
the first connector comprises multiple first compression connectors which protrude from the first connector surface,
the second connector comprises multiple second compression connectors which protrude from the second connector surface,
first compression connectors and second compression connectors are partially embedded in a flexible material;
the mating surfaces of the first connector and the second connector are substantially flat; and
the first compression connectors are configured to bend at a first direction, and the second compression connectors are configured to bend at a second direction, when the first connector is connected to the second connector of another stackable module.

7. A stackable module according to claim 6, wherein the mating surface of the first connector comprises at least one channel allowing accumulated water to flow out from the closed connection between two stackable modules, when the stackable module is connected to another stackable module.

8. A stackable module according to claim 6, wherein the mating surface of the module comprises a heating element configured to melt ice from the mating surface.

9. A stackable module according to claim 6, wherein the first compression connectors are configured to bend at a first direction, and the second compression connectors are configured to bend at a second direction, when the first connector is connected to the second connector of another stackable module.

10. A stackable module according to claim 9, wherein the angle between the first direction and the second direction is between 70 and 110 degrees.

11. A stackable module according to claim 6, wherein the flexible material is an elastomer.

12. A stackable module according to claim 6, wherein the compression connector is a spring-loaded pin.

13. A stackable module according to claim 6, wherein the mating surface comprises a hydrophobic coating.

14. A stackable module according to claim 6, wherein the stackable module comprises at least one function selected from the group of: camera, IR-camera, microphone, drone detection, drone interference, wired transceiver, wireless transceiver, motion sensor, passive infrared motion sensor, ultrasound motion sensor, light curtain, light gate, proximity sensor, illumination, detonation unit and self-destruction unit.

15. A stackable module according to claim 6, wherein the second connector comprises a power switch wherein a switch pin is partially embedded into the flexible material, and pressing the switch causes it to be in contact with a switch plate embedded inside the flexible material.
